(19) United States
(12) Patent Application Publication
(10) Pub. No.: US 2025/0232122 A1
(43) Pub. Date: Jul. 17, 2025

(54) ARTIFICIAL INTELLIGENCE DEVICE FOR EMOTION RECOGNITION USING JOINT AND UNIMODAL REPRESENTATION LEARNING WITH LATE FUSION AND METHOD THEREOF

(71) Applicant: LG ELECTRONICS INC., Seoul (KR)

(72) Inventors: Amirhossein HAJAVI, Toronto (CA); Homa FASHANDI, Toronto (CA); Harmanpreet SINGH, Toronto (CA)

(73) Assignee: LG ELECTRONICS INC., Seoul (KR)

(21) Appl. No.: 19/019,061

(22) Filed: Jan. 13, 2025

Related U.S. Application Data
(60) Provisional application No. 63/620,184, filed on Jan. 12, 2024.

(51) Int. Cl. G06F 40/30; G06F 18/25

(52) U.S. Cl. CPC G06F 40/30; G06F 18/25

(57) ABSTRACT

A method for controlling an artificial intelligence (AI) device can include receiving a video and an audio signal, generating a visual embedding and an audio embedding by visual and audio encoders, processing the visual embedding, by a unimodal visual transformer encoder, to generate an independent visual embedding vector, and processing the audio embedding, by a unimodal audio transformer encoder, to generate an independent audio embedding vector. The method can further include processing the visual and audio embeddings, by respective joint transformer encoders, to generate a joint visual embedding vector using cross-attention and a joint audio embedding vector using cross-attention, processing the independent visual and audio embedding vectors and the joint visual and audio embedding vectors to generate a global fused embedding vector, generating an emotion prediction using a classifier module that analyzes the global fused embedding vector, and outputting an emotion prediction based on the global fused embedding vector.

### CROSS-REFERENCE TO RELATED APPLICATIONS

This non-provisional application claims priority under 35 U.S.C. § 119 (e) to U.S. Provisional Application No. 63/620,184, filed on Jan. 12, 2024, the entirety of which is hereby expressly incorporated by reference into the present application.

### BACKGROUND

### Field

The present disclosure relates to a device and method for emotion recognition, in the field of artificial intelligence (AI). Particularly, the method can efficiently and accurately perform emotion recognition using joint and unimodal representation learning with late fusion.

### Discussion of the Related Art

Artificial intelligence (AI) continues to transform various aspects of society and help users by powering advancements in various fields, particularly with regards to interactive applications.

Emotion recognition plays an important role in human-computer interaction. For example, accurate emotion recognition can help enable more natural and empathetic communication between humans and machines, better understand a user's intent, and provide more useful responses and results.

However, existing approaches to emotion recognition suffer from several limitations. For example, existing models often rely on overly complex and computationally expensive systems. This complexity can hinder real-time applications and deployment on resource-constrained devices.

Further, existing methods may over rely on textual language for determining emotional states, which can lead to less accurate emotion recognition, especially when audio or visual cues may be dominant (e.g., tone of voice or vocal inflections, or facial expressions) or when textual language information may be misleading (e.g., when using sarcasm). For example, in the context of emotion recognition, phrases such as “He is so sick” which generally have a negative sentiment on their own, may have a positive interpretation when accompanied by an energetic voice and excited facial expressions of the speaker to have slang meaning of “He is so amazing or impressive.”

Also, the input that comes from other modalities may also have misleading information. For example, audio from background speech or people with different expressions stepping into the frame may wrongly change the outcome. Thus, there is a need for an emotion recognition model for multi-modal data that can better decide whether to incorporate information from other modalities while extracting data from each modality.

In addition, some emotion recognition systems (e.g., large, complex models) require transmitting raw video and audio data to a remote server for processing, which raises privacy concerns. This can limit the applicability of such systems in sensitive environments where data privacy and security are needed.

Thus, existing emotion recognition technology faces various challenges related to complexity, efficiency, over-reliance on language and privacy.

Accordingly, there exists a need for a method that can achieve accurate and efficient emotion recognition based on multiple modalities.

Further, a need exists for a method that can achieve a lighter and more efficient model without significantly sacrificing performance, which can facilitate deployment on resource-constrained devices and better support real-time applications.

For instance, there is a need for a more efficient, accurate and privacy-conscious solution for emotion recognition.

### SUMMARY OF THE DISCLOSURE

The present disclosure has been made in view of the above problems and it is an object of the present disclosure to provide a device and method that can provide emotion recognition, in the field of artificial intelligence (AI). Further, the method can provide a more efficient, accurate and privacy-conscious solution for emotion recognition while minimizing size.

An object of the present disclosure is to provide an artificial intelligence (AI) device and method for emotion recognition that can process audio and visual inputs through a joint and unimodal transformer-based architecture that can employ separate unimodal transformer encoders to process audio and visual information independently to capture modality-specific emotional cues while simultaneously employing joint transformer encoders to processes both audio and visual data together to learn cross-modal interactions and dependencies. Also, the method can further include a two-stage late-fusion mechanism that effectively integrates the unimodal and joint representations to provide a more comprehensive understanding of expressed emotions. In this way, by combining the advantages of both unimodal and joint representation learning, a more robust and accurate emotion recognition system can be provided while also minimizing size and complexity of the model.

Also, since the AI device and method utilizes both unimodal and joint representation learning, the overall AI model can be referred to as JUFORMER for ease of understanding, but embodiments are not limited to.

Another object of the present disclosure is to provide a method for controlling an artificial intelligence (AI) device that can include receiving, by a processor in the AI device, a video segment including a plurality of frames and an audio signal corresponding to the video segment, processing the video segment, by a visual encoder, to generate a visual embedding, processing the audio signal, by an audio encoder, to generate an audio embedding, processing the visual embedding, by a unimodal visual transformer encoder, to generate an independent visual embedding vector based on self-attention, processing the audio embedding, by a unimodal audio transformer encoder, to generate an independent audio embedding vector based on self-attention, processing the visual embedding, by a joint visual transformer encoder, to generate a joint visual embedding vector using cross-attention based on information from the audio embedding, processing the audio embedding, by a joint audio transformer encoder, to generate a joint audio embedding vector using cross-attention based on information from the video embedding, processing the independent visual embedding vector, the independent audio embedding vector, the joint visual embedding vector and the joint audio embedding vector, by a fusion module, to generate a global fused embedding vector, and generating an emotion prediction using a classifier module that analyzes the global fused embedding vector, and outputting the emotion prediction.

It is another object of the present disclosure to provide a method, in which the processing the independent visual embedding vector, the independent audio embedding vector, the joint visual embedding vector and the joint audio embedding vector, by the fusion module includes inputting the independent visual embedding vector and the joint visual embedding vector to a first partial fusion module to generate a first partially fused visual embedding vector, inputting the independent audio embedding vector and the joint audio embedding vector to a second partial fusion module to generate a second partially fused audio embedding vector, and processing the first partially fused visual embedding vector and the second partially fused audio embedding vector, by a global fusion module, to generate the global fused embedding vector.

Yet another object of the present disclosure is to provide a method that further includes generating the first partially fused visual embedding vector based on a sum of a first weight multiplied to the independent visual embedding vector and a second weight multiplied to the joint visual embedding vector, and generating the second partially fused visual embedding vector based on a sum of a third weight multiplied to the independent audio embedding vector and a second weight multiplied to the joint audio embedding vector.

An object of the present disclosure to provide a method that further includes generating the global fused embedding vector based on a sum of a fifth weight multiplied to the first partially fused visual embedding vector and a sixth weight multiplied to the second partially fused visual embedding vector.

Another object of the present disclosure to provide a method, in which the processing the visual embedding, by the joint visual transformer encoder, to generate the joint visual embedding vector using cross-attention includes using a query and a key received from the joint audio transformer encoder based on the audio embedding and a value internally generated by the joint visual transformer encoder based on the visual embedding.

An object of the present disclosure to provide a method, in which the processing the audio embedding, by the joint audio transformer encoder, to generate the joint audio embedding vector using cross-attention includes using a query and a key received from the joint visual transformer encoder based on the visual embedding and a value internally generated by the joint audio transformer encoder based on the audio embedding.

Yet another object of the present disclosure to provide a method, in which the processing the video segment, by the visual encoder, to generate the visual embedding includes resizing the plurality of frames within the video segment to a size of N×N pixels to generate resized frames where N is a positive number, dividing the resized frames into M×M non-overlapping patches where M is less than N, applying a first convolutional neural network (CNN) to project the M×M non-overlapping patches into fixed-sized visual vectors, the visual embedding being one of the fixed-sized visual vectors.

An object of the present disclosure to provide a method, in which the processing the audio signal, by the audio encoder, to generate the audio embedding includes converting the audio signal to mel-spectrograms, and applying a second convolutional neural network (CNN) to extract fixed-sized audio based vectors, the audio embedding being one of the fixed-sized audio based vectors.

Another object of the present disclosure to provide a method, in which each of the unimodal visual transformer encoder, the unimodal audio transformer encoder, the joint visual transformer encoder and the joint audio transformer encoder includes only a single transformer block.

An object of the present disclosure to provide a method, in which one or more of the unimodal visual transformer encoder, the unimodal audio transformer encoder, the joint visual transformer encoder and the joint audio transformer encoder includes a transformer tower including a plurality of transformer blocks.

An object of the present disclosure to provide a method, in which the generating the emotion prediction using the classifier module includes mapping the global fused embedding to a set of probabilities corresponding to a plurality of emotions, and selecting an emotion among the plurality of emotions having a highest probability as the emotion prediction.

Another object of the present disclosure is to provide an artificial intelligence (AI) device including a memory configured to store video and audio information, and a controller configured to receive a video segment including a plurality of frames and an audio signal corresponding to the video segment, process the video segment, by a visual encoder, to generate a visual embedding, process the audio signal, by an audio encoder, to generate an audio embedding, process the visual embedding, by a unimodal visual transformer encoder, to generate an independent visual embedding vector based on self-attention, process the audio embedding, by a unimodal audio transformer encoder, to generate an independent audio embedding vector based on self-attention, process the visual embedding, by a joint visual transformer encoder, to generate a joint visual embedding vector using cross-attention based on information from the audio embedding, process the audio embedding, by a joint audio transformer encoder, to generate a joint audio embedding vector using cross-attention based on information from the video embedding, process the independent visual embedding vector, the independent audio embedding vector, the joint visual embedding vector and the joint audio embedding vector, by a fusion module, to generate a global fused embedding vector, and generate an emotion prediction using a classifier module that analyzes the global fused embedding vector, and output the emotion prediction.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example flow chart for a method of controlling an AI device to perform emotion recognition according to an embodiment of the present disclosure.

FIG. 5 illustrates an overview of the architecture of an AI model for emotion recognition, according to an embodiment of the present disclosure.

FIG. 6, including parts (a), (b) and (c), illustrate components of a visual encoder and an audio encoder, according to an embodiment of the present disclosure.

FIG. 7 illustrates an internal architecture of a unimodal transformer encoder, according to an embodiment of the present disclosure.

FIG. 8 illustrates an internal architecture of a joint transformer encoder, according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

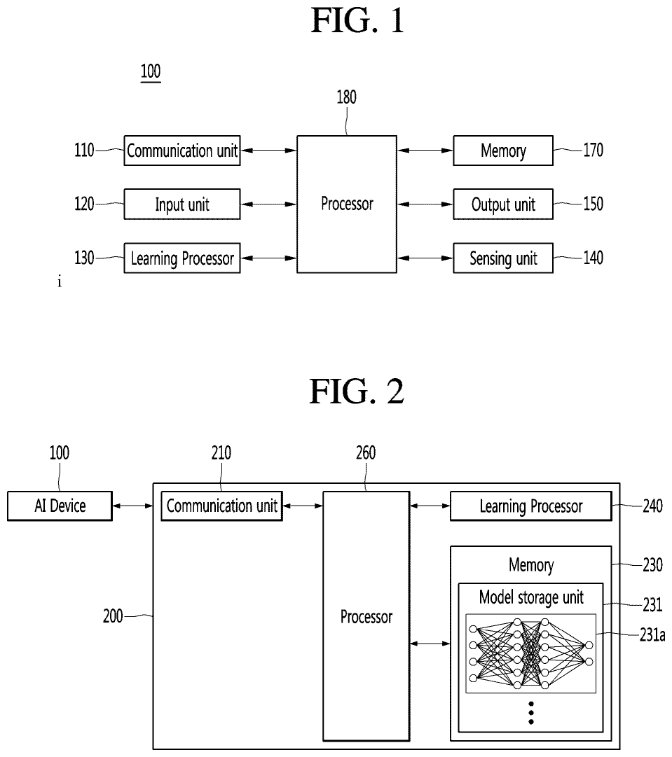

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

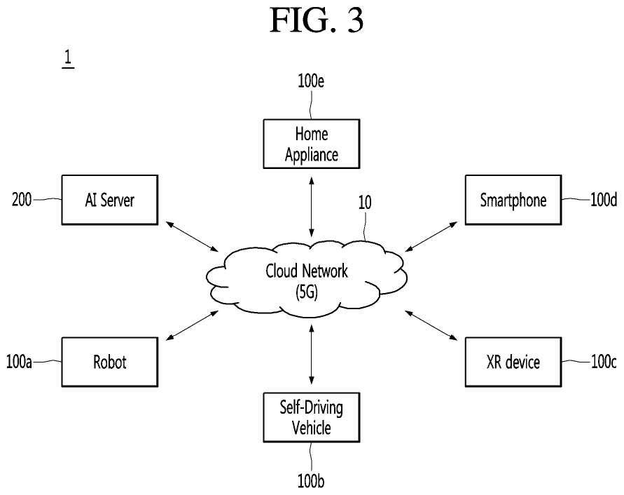

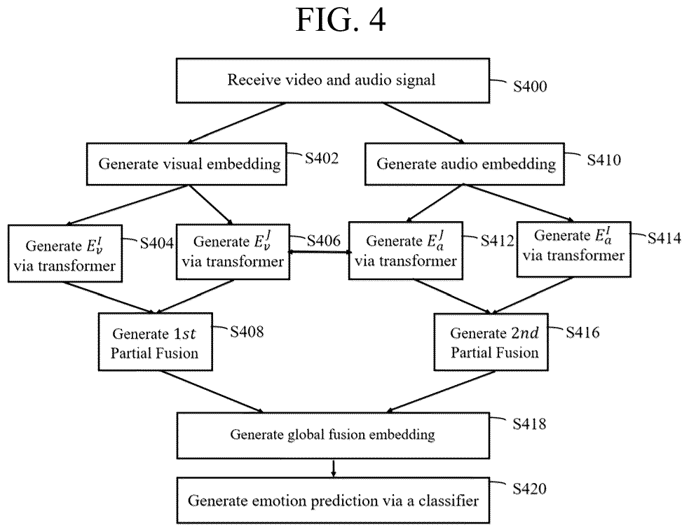

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire learning data for model learning and input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement a joint and unimodal representation learning, transformer based emotion recognition (JUFORMER) AI model to recognize and identify emotions based on a plurality of modalities. Also, the identified emotions can be used by AI systems in various downstream related tasks.

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

The processor 180 can acquire information from the user input and can determine an emotional state of the user and produce an answer to a query, carry out an action or movement, animate a displayed avatar or a recommend an item or action based on the determined emotional state.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data. According to embodiments, the JUFORMER model can be fully implemented on an edge device (e.g., locally on devices 100a to 100e) or fully implemented AI server 200 in which an edge device collected the raw audio and video signals to provide to the AI server 200. According to another embodiment, parts of the JUFORMER model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

In addition, the AI server 200 can learn the artificial neural network according to the machine learning algorithm instead of the AI devices 100a to 100e, and can directly store the learning model or transmit the AI model to the AI devices 100a to 100e.

Further, the AI server 200 can receive input data from the AI devices 100a to 100e, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart refrigerator or other display device, which can implement one or more of a digital avatar assistant, a question and answering system or a recommendation system, etc. The method can be the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. At this time, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar, which can be personally tailored to the user based on the user's emotional state.

According to an embodiment, the AI device 100 can provide a joint and unimodal representation learning, emotion recognition (JUFORMER) AI model which can automatically determine an emotional state of a user.

According to another embodiment, the AI device 100 can be integrated into an infotainment system of the self-driving vehicle 100b, which can recognize different users and their emotional states, and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

Emotion recognition (ER) can determine human emotions by analyzing physiological or physical signals. By focusing on non-invasive modalities like facial expressions and voice, emotion recognition can facilitate natural and intuitive human-computer interactions. According to an embodiment, the emotion recognition AI model can leverage audio and visual information to provide insights into a user's emotional state, which can provide more empathetic and personalized computing experiences.

In addition, the AI device 100 can provide automated emotion recognition (ER) which can empower technology with the ability to perceive human emotions. While physiological data like EEG, heart rate and ECG can offer deep insights into emotional states, their invasive nature limits their use in everyday technology. According to an embodiment, the AI device 100 can focus on non-invasive modalities such as facial expressions and vocal tone, which can be captured by cameras and microphones. By analyzing the collected information, the AI device 100 can detect the emotional state of a user, and enable more natural and empathetic human-computer interaction in various applications, such as home robots and personal assistants.

In addition, the detected emotional state of a user can be utilized by other downstream applications to provide emotionally aware responses, e.g., empathetic conversations or offering mood regulation strategies. Also, the emotion recognition task can be formulated as a multi-label classification task in which multiple basic emotions model complex emotions. The basic emotions can include anger, disgust, fear, happiness, sadness and surprise, but embodiments are not limited thereto.

As discussed above, emotion recognition technology faces several challenges. Many existing models are complex and computationally expensive, hindering real-time use and deployment on devices with limited resources. Additionally, some methods over-rely on textual information, which can be misleading or less informative than audio cues like tone of voice. Also, transmitting data to remote servers can raise privacy concerns. These issues highlight the need for more efficient, accurate and privacy-preserving approaches to emotion recognition.

Also, existing transformer-based approaches that use multi-modal data can be categorized into two formats: single-stream or dual-stream data. In single-stream scenarios where the input vectors are formed by concatenating signals from all modalities, the encoder's complexity is much higher than models using a dual-stream format. In the dual-stream scenario, where the two modalities are not concatenated at the input level, models often use a simple fusion mechanism or minimal fusion after the encoders. Using a minimal fusion entails a more complex encoder which can increase size and complexity.

According to an embodiment, the AI device 100 implementing the JUFORMER model can processes audio and video data through separate and combined pathways, using transformers and a two-stage fusion mechanism to effectively capture and integrate unimodal and cross-modal features for accurate emotion recognition. In this way, an accurate, robust and more compact model can be provided. Also, the number of parameters of the AI model can be substantially reduced, which provides added benefits.

According to an embodiment, the JUFORMER model can include a visual encoder and an audio encoder, each of which is followed by a unimodal transformer encoder and a joint transformer encoder to generate independent and joint embeddings. Then, the independent and joint embeddings for each of the visual and audio data can be combined by corresponding partial fusion modules. The outputs of the two partial fusion modules can be combined by a global fusion model which is connected to a classifier which can determine the emotional state.

In more detail, the AI model can have a sophisticated architecture that effectively captures and integrates audio-visual features for enhanced emotion recognition, which is based on joint and unimodal representation learning, coupled with a two-stage late-fusion mechanism.

Further, the AI model can use separate visual and audio encoders for processing raw audio and video inputs. The visual and audio encoders can convert audio data into mel-spectrograms and resize video frames before dividing them into patches. Both audio and video patches can then be processed by a corresponding 2D Convolutional Neural Network (CNN) to extract relevant features and generate fixed-size embedding vectors.

In addition, the visual and audio embedding vectors can be fed into unimodal transformer encoders, which process audio and video information independently. This unimodal processing can allow the model to capture modality-specific emotional cues without the influence of cross-modal interactions. In parallel to the unimodal processing, joint transformer encoders can process information from both the audio and video embeddings together, leveraging cross-modal attention mechanisms to learn intricate relationships and dependencies between the different modalities.

According to an embodiment, the AI model can employ a two-stage late-fusion mechanism to effectively integrate the information extracted from both of the unimodal and joint processing. For example, the first stage (e.g., partial fusion) can combine the unimodal and joint embeddings for each modality, creating a richer representation. The second stage (e.g., global fusion) can merge the partially fused embeddings from both audio and visual streams, resulting in a comprehensive representation that encapsulates both modality-specific and cross-modal information.

Further in this example, an emotion classifier can receive the final merged embedding as an input and predict the emotion expressed in the audio-visual data. This sophisticated architecture can allow the JUFORMER model to achieve enhanced performance on emotion recognition tasks in both accuracy and efficiency while also minimizing the size of the model. In other words, according to an embodiment, the combination of joint and unimodal learning, along with the two-stage late fusion can enable the model to capture a wider range of emotional cues, leading to improved robustness and performance. Also, the AI model can have a smaller size compared to other models, making it more computationally efficient.

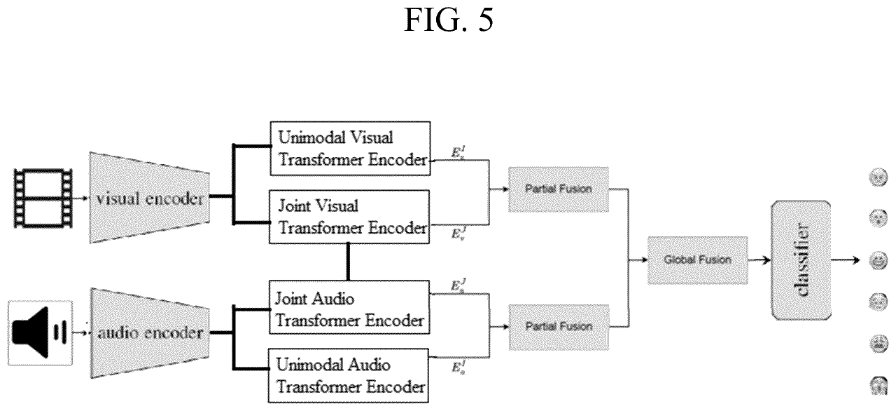

FIG. 4 shows an example flow chart of a method according to an embodiment. For example, according to an embodiment, a method for controlling an AI device to perform emotion recognition can include receiving, by a processor in the AI device, a video segment including a plurality of frames and an audio signal corresponding to the video segment (e.g., S400), processing the video segment, by a visual encoder, to generate a visual embedding (e.g., S402), and processing the audio signal, by an audio encoder, to generate an audio embedding (e.g., S410).

In addition, the method can further include processing the visual embedding, by a unimodal visual transformer encoder, to generate an independent visual embedding vector based on self-attention (e.g., S404), processing the audio embedding, by a unimodal audio transformer encoder, to generate an independent audio embedding vector based on self-attention (e.g., S414), processing the visual embedding, by a joint visual transformer encoder, to generate a joint visual embedding vector using cross-attention based on information from the audio embedding (e.g., S406), and processing the audio embedding, by a joint audio transformer encoder, to generate a joint audio embedding vector using cross-attention based on information from the video embedding (e.g., S412).

Further in this example, the method can further include processing the independent visual embedding vector and the joint visual embedding vector, by a first partial fusion module, to generate a first partially fused embedding vector (e.g., S408).

Further still in this example, the method can further include processing the independent audio embedding vector and the joint audio embedding vector, by a second partial fusion module, to generate a second partially fused embedding vector (e.g., S416).

Then, the method can include processing the first and second partially fused embedding vectors, by a global fusion module, to generate a global fused embedding vector (e.g., S418). Further, the method can include generating an emotion prediction using a classifier module that analyzes the global fused embedding vector, and outputting the emotion prediction (e.g., S420).

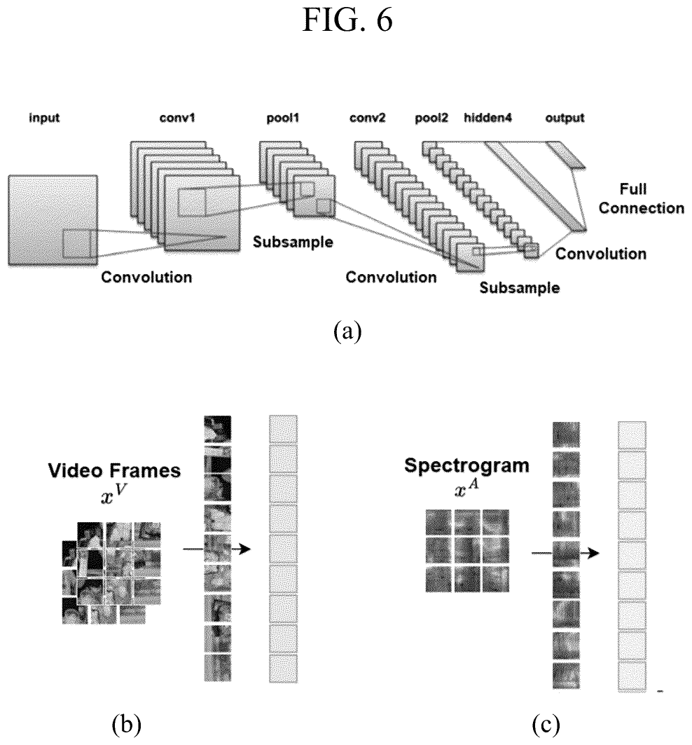

FIG. 5 illustrates an overview of the architecture of an AI model for emotion recognition, according to an embodiment of the present disclosure.

For example, the AI device 100 can include a visual encoder (e.g., visual modality) and an audio encoder (e.g., audio modality), and each of the visual and audio encoders can be connected to corresponding unimodal and joint transformer encoders. The visual encoder can also be referred to as a video encoder, but embodiments are not limited to.

As discussed above, the outputs of the transformer encoders can be connected to a corresponding partial fusion module, and the outputs of the partial fusion modules can be connected to a global fusion module. Further, the output of the global fusion model can be connected to a classifier module that is configured to predict the expressed emotion.

For example, the AI device 100 can receive a video segment that includes corresponding audio and can automatically determine the dominant emotion that is contained within that segment.

With reference again to FIG. 5, the visual encoder can receive a video segment including a plurality of frames as an input. For example, the video segment can be video captured at 25 frames per second, but embodiments are not limited thereto and other frame rates can be utilized.

The visual encoder can effectively capture and represent the spatiotemporal information present in video data. According to an embodiment, this process can begin by resizing each frame in the input video sequence to a resolution of 225×225 pixels to ensure consistency in input dimensions, but embodiments are not limited thereto. For example, the frames can be resized to other resolutions depending on embodiments and design considerations.

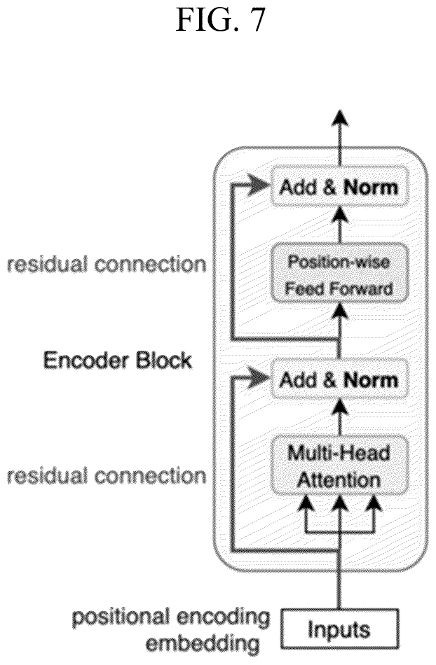

Then the resized frames can be divided into non-overlapping patches of 16×16 pixels each. FIG. 6, part (b) shows an example in which a frame is divided into 9 patches, but embodiments are not limited thereto. These patches can serve as localized regions of interest, capturing distinct visual features within the frame.

Further in this example, the visual encoder can employ a 2D Convolutional Neural Network (CNN) layer as shown in FIG. 6, part (a) to extract meaningful representations. For example, the CNN layer can utilize a kernel size of 16×16 which matches the dimensions of the patches, and can have 768 channels. Each channel can act as a feature detector that learns to identify specific patterns or characteristics within the input patches. The CNN layer effectively projects each 16×16 patch into a fixed-size vector of 768 dimensions, capturing a rich set of visual features. However, embodiments are not limited thereto, and the fixed-size visual embedding vector can have a different number of dimensions, according to embodiments and design considerations.

For example, the CNN architecture can include a series of layers, each designed to progressively transform the input data into a more abstract and informative representation.

The process can begin with the input layer, which receives the patches extracted from the resized video frames. The first convolutional layer (e.g., conv1) can applies a set of learnable filters to the input data. These filters can slide across the input, performing convolution operations that extract local features (e.g., edges, textures, and frequency patterns, etc.). The output of conv1 can then passed through a pooling layer (e.g., pool1), which can perform subsampling. The subsampling can reduce the dimensionality of the data while retaining the salient features.

This type of process can be repeated with another convolutional layer (e.g., conv2) and pooling layer (e.g., pool2). For example, conv2 layer can apply a new set of filters to the output of pool1 to extract higher-level features and patterns. The pool2 layer can then perform another round of subsampling, which can further reduce the dimensionality and increase the robustness of the representation.

Further in this example, The output of pool2 layer can be passed to a fully connected layer (e.g., hidden4). This layer can connect every neuron from the previous layer to every neuron in the current layer to allow the network to learn complex non-linear relationships between the extracted features. Then, the output layer can produce a representation of the input data as a 768-dimensional embedding vector. In this way, the CNN can progressively extract more abstract and meaningful features at each layer, and transform the visual data into a compact and informative representation. A similar process can be applied to the mel-spectrogram representation of the audio signal with another 2D CNN layer in the audio encoder.

In addition, to preserve information about the spatial and temporal arrangement of these patches within the video sequence, positional encodings can used. These positional encodings (e.g., spatiotemporal information) can provide a contextual representation of where each patch is located within the frame and its position in the overall video sequence.

Further, the visual encoder can output a series of 768-dimensional embedding vectors for the patches across all frames and input the 768-dimensional embedding vectors to both a unimodal visual transformer encoder and a joint visual transformer encoder, which is described in more detail at a later section.

With reference again to FIG. 5, the audio encoder is responsible for processing the audio input and generating representations that capture the emotionally relevant information in the sound.

For example, the audio signal corresponding to a given video segment can include useful information for determining emotions. The audio signal can include speech that is used in conversations to communication information with words but also can contain a lot of non-linguistic information, such as nonverbal expressions (e.g., laughs, breaths, sighs, etc.) and prosody features (e.g., intonation, speaking rate, etc.). This can provide important information for emotion recognition.

The audio encoder can receive an audio signal as input and generate a mel-spectrogram, which can be converted to a suitable format (e.g., a series of vectors) as input to the corresponding unimodal and joint transformer encoders. The audio signal can be audio information that is sampled at 16 kHz, but embodiments are not limited thereto.

In more detail, according to an embodiment, the audio encoder can be used to process and represent audio information for enhanced emotion recognition. For example, understanding the nuances of human speech, such as the emotional cues embedded in vocal inflections and tones, can benefit from a representation that aligns with human auditory perception. To achieve this, the JUFORMER model can leverage mel-spectrograms.

For example, a mel-spectrogram can provide visual representations of the frequency content of a sound signal over time. Spectrograms can be generated by applying Fourier analysis to the audio signal, decomposing it into a sum of sinusoids with varying frequencies and amplitudes. By capturing these frequency components and their respective amplitudes over consecutive time windows, a spectrogram can provide a dynamic “picture” of the sound's frequencies in the audio.

Also, human hearing is not linear, rather it is more attuned to changes in lower frequencies than higher ones. The mel-spectrogram addresses this by incorporating the mel scale, which is a perceptual scale that approximates how humans perceive pitch.

Accordingly to an embodiment, the audio encoder can use mel filter banks to compress the spectrogram by allocating higher resolution to lower frequencies and lower resolution to higher frequencies. This results in a representation that is more aligned with human auditory perception, which can be helpful for analyzing emotional cues in speech. For example, the mel-spectrogram can be considered as a type of specialized heat map that is tailored to visualize the frequency characteristics of audio signals.

Also, the mel-spectrograms generated by the audio encoder can be extracted using the Librosa library, but embodiments are not limited thereto.

According to an embodiment, the mel-spectrogram can be constructed with 128 frequency bins, effectively dividing the audio frequency spectrum into 128 distinct ranges. This transformation can result in a two-dimensional representation of the audio signal, where the horizontal axis represents time and the vertical axis represents frequency.

In addition, the audio encoder further employs 2D Convolutional Neural Network (CNN) layer, such as shown in FIG. 6, part (b), in a similar manner as the visual encoder. The CNN layer can operate on the mel-spectrogram using a kernel size of 16×16 and 768 channels. Each channel can act as a feature detector, learning to identify specific patterns or characteristics within the localized regions of the mel-spectrogram. The CNN layer can extract a fixed-size embedding vector of 768 dimensions from the mel-spectrogram to capture a rich set of audio features.

However, embodiments are not limited thereto, and the fixed-size audio embedding vector can have a different number of dimensions, according to embodiments and design considerations.

In addition, the resulting 768-dimensional audio vector embeddings can be marked with a spatio-temporal embedding before being passed to the corresponding unimodal and joint transformers as input.

As shown in FIG. 5, the visual encoder can be connected to a unimodal transformer encoder and a joint transformer encoder, and the audio encoder can be connected to a unimodal transformer encoder and a joint transformer encoder. For example, each of the visual encoder and the audio encoder can be connected to their own dedicated unimodal transformer encoder and joint transformer encoder, as shown in FIG. 5.

According to an embodiment, each of the unimodal transformer encoders can play an important role in capturing modality-specific emotional cues by processing audio and visual information independently. This independent processing can allow the model to focus on the unique characteristics of each modality without the influence of cross-modal interactions, which could potentially obscure subtle unimodal cues.

For example, the AI model can employ separate transformer blocks for audio and visual data. Each transformer block is equipped with self-attention mechanisms.

These self-attention mechanisms can allow the model to weigh the importance of different parts of the input sequence within the same modality to capture intricate relationships and dependencies between elements within that modality. For instance, in the audio modality, the self-attention mechanism might focus on the relationship between consecutive audio frames or the interplay between different frequency components. Similarly, in the visual modality, it might capture the interaction between different spatial regions or the temporal evolution of visual features.

Further in this example, this unimodal processing results in distinct embedding representations for video and audio, denoted as Eᵥ^{I} and Eₐ^{I} in FIG. 5, respectively. These embeddings can encapsulate the rich unimodal information extracted by the respective transformer encoders. By processing each modality independently, the unimodal transformer encoder can ensure that modality-specific emotional cues are captured effectively to provide a foundation for the subsequent fusion stage where information from both modalities can be integrated together.

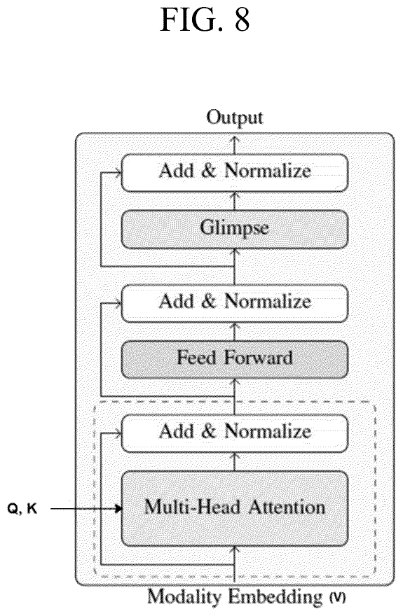

According to an embodiment, each of the unimodal transformer encoder for the visual data and the unimodal transformer encoder for of the audio data can be implemented by a single transformer block as shown in FIG. 7, which can help contribute to the model having a fewer number of parameters and smaller size. However, embodiments are not limited thereto. For example, according to another embodiment, each of the unimodal transformer encoder for the visual data and the unimodal transformer encoder for the audio data can be implemented by a transformer tower including a plurality of transformer blocks (e.g., two or more transformers) which can further increase accuracy but at the expense of a larger model size.

FIG. 7 shows an example internal architecture for each of the unimodal transformer encoder for the visual data and the unimodal transformer encoder for of the audio data, according to an embodiment. The unimodal transformer encoders can perform self-attention within their own corresponding mobility (e.g., visual or audio).

For example, each of the unimodal transformer encoders can be implemented by a single transformer block having an architecture that includes a multi-head attention layer followed by an add and normalize layer, a position-wise feed-forward layer, and another add and normalize layer.

The multi-head attention layer can allow the model to attend to different parts of the input sequence simultaneously to capture diverse aspects of the data. The multi-head attention layer can be followed by an add and normalize layer, which adds the output of the attention layer to its input and then applies layer normalization to stabilize the learning process.

Next, a position-wise feed-forward layer can be applied to each position in the sequence, which can include two dense layers and a non-linear activation function in between (e.g., such as ReLu). Then, another add and normalize layer can applied to the output of the feed-forward layer, further stabilizing the learning process.

In this way, the unimodal transformer encoder can effectively capture complex dependencies and relationships within each modality (e.g., the visual modality and the audio modality). By processing audio and visual information separately through these specialized transformer blocks, the AI model can ensure that modality-specific emotional cues are preserved and effectively represented in the unimodal embeddings, Eᵥ^{I} and Eₐ^{I}. These embeddings then serve as inputs to the subsequent fusion stage, which is discussed in more detail below.

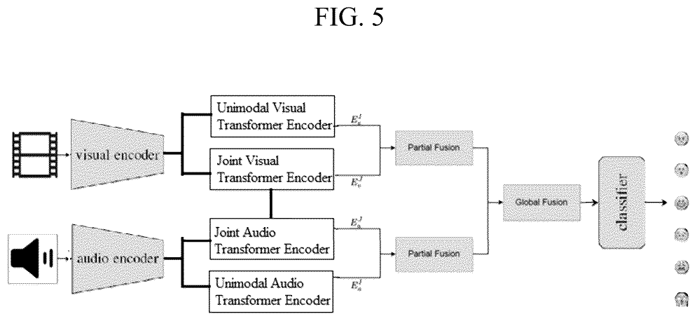

FIG. 8 shows an example internal architecture for each of the joint transformer encoder for the visual data and the joint transformer encoder for of the audio data, according to an embodiment. The joint transformer encoders can perform cross-attention between the modalities.

For example, each joint transformer encoder can capture intricate cross-modal relationships between audio and visual information, which can enable a deeper understanding of the combined emotional content.

Unlike the unimodal transformer encoders that process each modality independently, the joint transformer encoders receive information from both audio and visual streams. Further, a cross-modal attention mechanism is employed. This mechanism leverages the “Key, Query, and Value” (KQV) triplet concept, but with an adaptation for cross-modal learning.

For example, the joint transformer encoder for the visual data can takes the “Value” (V) from the visual modality and the “Key” (K) and “Query” (Q) from the audio modality. And the joint transformer encoder for the audio data operates in a similar matter but takes V from the audio modality and K and Q from the visual modality.

For example, for each embedding in the input sequence received by the transformer, three separate linear transformations can be applied to the Query (Q), Key (K) and Value (V), which can be represented as matrices.

The Query (Q) can represent what the current embedding is looking for, the Key (K) can represent what the current embedding offers or how it can be matched by other embeddings, and the Value (V) can represent the actual information content of the current embedding, but embodiments are not limited thereto.

For example, each embedding's query can be compared to the keys of others to generate attention scores that are normalized into weights. These weights can be used to create a weighted sum of the values to form a contextualized representation that incorporates information from relevant embeddings.

This configuration can allow the AI model to attend to the information from one modality (V) based on the guidance provided by the other modality (K and Q). For instance, the model might attend to specific visual features (V) based on the queries and keys generated from the audio information (K and Q), or vice versa. This cross-modal attention mechanism enables the AI model to learn how different aspects of audio and visual data relate to each other and contribute to the overall emotional expression.

The output of each joint transformer encoder is a set of joint embeddings, denoted as Eᵥ^{J} and Eₐ^{J}, in FIG. 5, respectively. These joint embeddings represent information from both modalities based on cross-attention. The joint embeddings and the unimodal embeddings are then fed into the corresponding partial fusion modules.

According to an embodiment, each of the joint transformer encoder for the visual data and the joint transformer encoder for of the audio data can be implemented by a single transformer block using a cross-attention mechanism as shown in FIG. 8, which can also help contribute to the model having a fewer number of parameters and smaller size. However, embodiments are not limited there to. For example, according to another embodiment, each of the unimodal transformer encoder for the visual data and the unimodal transformer encoder for the audio data can be implemented by a transformer tower including a plurality of transformer blocks (e.g., two or more transformers).

For example, the single transformer block in each of the joint transformer encoders can use a combination of attention mechanisms, feed-forward networks, and residual connections to effectively process and refine the input embeddings. Also, an add and normalize layer can be applied after each of the multi-head attention, feed-forward, and glimpse layers.

In more detail, the multi-head attention layer can take the input embeddings and calculate attention scores between different parts of the sequence. It uses multiple heads to attend to different aspects of the input simultaneously. This can allow the model to capture relationships and dependencies between different elements in the sequence, such as how different visual features in a video sequence relate to each other or how different parts of a mel-spectrogram contribute to the overall emotional expression.

Also, the transformer block performs cross-attention using value (V) from one modality and the key (K) and value (V) from the other modality.

Further, a first add and normalize layer can receive the output from the multi-head attention block and add it to the original input embedding (e.g., residual connection) and is normalized. This can help preserve information and improve training stability, and the normalized result can help prevent vanishing or exploding gradients during training. For example, the normalization can adjust the values within a layer to keep them within a reasonable range.

In addition, a first feed forward layer can apply a feed-forward neural network to each position in the sequence independently. For example, the feed-forward layer can act as a fully connected neural network layer that takes the output from the attention mechanism and further transforms it by applying non-linear transformations, allowing the model to learn complex patterns and improve the final output. In other words, it can help the model lean complex non-linear relationships within the data.

Also, a second add and normalize layer can receive the output from the first feed forward layer, in which the output of the first feed-forward layer is added to its input (e.g., residual connection) and normalized.

Further, a glimpse layer can receive the output from the second add and normalize layer. For example, the glimpse layer can take multiple “glimpses” at the input representation, each focusing on different parts of the input. The glimpse layer can use a soft attention mechanism to calculate attention weights for each element in the sequence. Then, outputs from all of the glimpses can stacked together or combined to create a new representation that incorporates information from different perspectives.

In addition, a third add and normalize layer can receive the output from the glimpse layer, in which the output of the glimpse layer is added to its input (e.g., residual connection) and normalized.

For example, the final output of the transformer block is a refined representation of the input sequence which can incorporate information about relationships between different elements and capture complex patterns within the data. This refined representation can then be passed to the fusion module for further processing.

For example, the transformer block can receive a sequence of vectors as input (e.g., audio embeddings, or visual embeddings), process this sequence through multi-head attention, feed-forward networks, and glimpse layers, refining the representation and capturing relationships between different elements in the sequence, and then output another sequence of vectors.

Also, the vectors output by the transformer block can have the same length as the input sequence. Each vector in the output sequence can correspond to a vector in the input sequence, but it has been transformed and enriched with contextual information from the entire sequence. The vectors can be 768-dimensional vectors, but embodiments are not limited thereto.

In more detail, according to an embodiment, the visual modality can attend to the audio information and vice-versa, via the cross attention mechanism by which the model can intelligently focus on and incorporate relevant visual or auditory cues to enhance its understanding of the visual scene or the audio segment.

For example, in a situation where a person in a video segment is smiling, but his or her voice is trembling. If the model relied solely on the visual information, it might incorrectly interpret the emotion as happy. However, by “attending” to the audio information (e.g., the trembling voice), the visual modality can gain a deeper understanding of the situation. This cross-modal attention can allow the JUFORMER model to recognize that the trembling voice indicates nervousness or fear, even though the person is smiling.

In other words, the cross attention feature can allow the visual and audio modalities to use information from the other modality as a guide to focus on the most important parts of the sequence. In this way, a better informed and more accurate representation of the emotional state can be determined by the model.

Further, the separation of unimodal and joint processing contributes to AI model's ability to achieve smaller size and a comprehensive and nuanced understanding of emotions expressed through audio-visual data, which is discussed in more detail below regarding the late fusion stage.

With reference again to FIG. 5, the AI model can include two partial fusion modules. For example, a first partial fusion module can be connected to the output of the unimodal transformer encoder and the joint transformer encoder for the visual data, and a second partial fusion module can be connected to the output of the unimodal transformer encoder and the joint transformer encoder for the audio data.

The partial fusion modules can integrate the information extracted from both unimodal and joint processing of audio-visual data. This module can act as an intelligent aggregator by selectively combining the unimodal embeddings (e.g., Eᵥ^{I}, or Eₐ^{I}) and the joint embeddings (e.g., Eᵥ^{J}, or Eₐ^{J}) to create a more informative representation for each modality.

According to an embodiment, each of the partial fusion modules can employ an attention mechanism coupled with learnable weights. The attention mechanism can focus on the most salient features within both the unimodal and joint embeddings by identifying the most relevant information captured by each processing stream. This attention-guided selection can ensure that the most important aspects of both unimodal and joint representations are prioritized.

For example, the learnable weights can refine this integration process. These weights can be automatically adjusted during the training process, allowing the model to learn the optimal balance between the unimodal and joint embeddings of the respective modality. This dynamic weighting can allow the contributions of each embedding to be appropriately scaled based on their relevance to the overall emotion recognition task.

The output of the partial fusion modules can be a set of partially fused embeddings (e.g., F_video and F_audio). These embeddings can represent a weighted combination of the unimodal and joint embeddings where the weights are determined by both the attention mechanism and the learned weights. This fusion process integrates the modality-specific information captured by the unimodal transformer encoder along with the cross-modal relationships captured by the joint transformer encoder to generate a more comprehensive and nuanced representation for each modality. The outputs of the two partial fusion modules can be transmitted to a global fusion module where information from both modalities can be further integrated for a better understanding of the expressed emotions.

According to an embodiment, the first partial fusion module connected to the output of the unimodal transformer encoder and the joint transformer encoder for the visual data can be implemented by a learnable neural network that performs the function of output fused embedding F_video=(weight1×Eᵥ^{I})+(weight2×Eᵥ^{J}).

Similarly, the second partial fusion module connected to the output of the unimodal transformer encoder and the joint transformer encoder for the audio data can be implemented by another learnable neural network that performs the function of output fused embedding F_audio=(weight3×Eₐ^{I})+ (weight4×Eₐ^{J}). Then, the partially fused output embeddings F_video and F_audio can be sent to the global fusion module.

According to an embodiment, the global fusion module can have a similar architecture as the partial fusion modules. For example, the global fusion module can be implemented by another learnable neural network that performs the function of output a global fused embedding=(weight5×F_video)+(weight6×F_audio). Then, the final merged embedding can be sent to the classifier module. The final merged embedding can be a 768 dimensional vector, but embodiments are not limited thereto.

The classifier module can receive the final merged embedding vector from the global fusion module. According to an embodiment, the classifier module can be implemented as a fully connected neural network trained to recognize patterns and relationships within the fused representation that correspond to different emotional states.

For example, the classifier module can map the fused representation to a set of probabilities, in which each of the probabilities represent a likelihood of a specific emotion being expressed. The emotions can include anger, disgust, fear, happiness, sadness, and surprise, but embodiments are not limited thereto. Then, the classifier module can select the emotion with the highest probability as the final prediction, which is based on the combined modalities (e.g., audio and visual).

According to another embodiment, the JUFORMER AI model can omit one or both of the unimodal transformer encoders and utilize only the joint transformer encoders. In this situation, the partial fusion modules can operate to highlight the salient parts of the embedding vector generated by the corresponding joint transformer encoder. In this way, the size and complexity of the model can be further reduced and accuracy may even be enhanced for determining some emotions. However, embodiments are not limited thereto.

According to an embodiment, the JUFORMER AI model can be trained using the binary cross-entropy (BCE) loss function. However, embodiments are not limited thereto and other types of loss functions can be used, such as a mean squared error (MSE) loss or focal loss or weighted versions of these losses.

For example, during training, the model can receive labeled data (e.g., a video segment and a corresponding audio signal) in which an input sample is associated with a specific emotion category. The JUFORMER model can then predict probabilities for each emotion and compare the results to the true labels, and the binary cross-entropy loss can quantify the difference between the predictions and the ground truth.

The loss value can guide the optimization process which can include iteratively adjusting the model's internal parameters to minimize the difference between its predictions and the true emotional labels. By repeatedly evaluating the loss and updating the model's parameters, the JUFORMER model can gradually learn to accurately recognize emotions from the input multimodal data, effectively minimizing the binary cross-entropy loss and improving its performance over time.

During inference time, the process is similar, except the loss function is not computed and the final predication is used as the output.

Various experiments were carried out against related art emotion recognition models (e.g., a textless vision-language transformer (TVLT) model and a transformer-based joint-encoding (TBJE) model) using weighted accuracy (WA) and weighted F1 (WF1) to evaluate the results, and the CMU-MOSEI dataset.

As shown in Table I below, the JUFORMER AI model according to embodiments either outperforms other methods or at least performs comparably, while also having a much smaller size and fewer parameters.

TABLE I

| | Happy | | Sad | | Angry | | Fear | | Disgust | | Surprise | | Average | |
|---|---|---|---|---|---|---|---|---|---|---|---|---|---|---|
| Method | WA | WF1 | WA | WF1 | WA | WF1 | WA | WF1 | WA | WF1 | WA | WF1 | WA | WF1 |
| TBJE | 65.0 | 64.0 | 72.0 | 67.9 | 81.6 | 74.7 | 89.1 | 84.0 | 85.9 | 83.6 | 90.5 | 86.1 | 80.6 | 76.7 |
| TVLT | 65.1 | 64.1 | 72.2 | 70.0 | 69.9 | 72.1 | 68.5 | 88.0 | 68.8 | 79.6 | 62.1 | 87.4 | 67.7 | 76.8 |
| JUFORMER | 59.9 | 60.0 | 53.7 | 80.1 | 54.2 | 77.9 | 50.0 | 95.0 | 52.8 | 85.1 | 49.9 | 95.6 | 51.9 | 82.2 |

As shown above, the results include the weighted accuracy and weighted F1 for each emotion category. Also, the number of parameters used during testing is included and the modality encoders, which can be viewed as a proxy for the size of the different models.

As shown in Table II below, the JUFORMER AI model according to embodiments has a much smaller size and fewer parameters than the other methods (e.g., TBJE and TVLT).

TABLE II

| Model | Modalities | # of Parameters (M) |
|---|---|---|
| TBJE | Audio, Visual, Text | 128.3 |
| TVLT | Audio, Visual | 88.6 |
| JUFORMER | Audio, Visual | 23.5 |

As shown by the results, while using fewer modalities compared to the TBJE model and outperforming it by a large margin, the JUFORMER model has less than 17% of the parameters of the TBJE model.

Furthermore, by comparing JUFORMER to TVLT, there is more than a 70% reduction in the number of parameters. This may be attributed to the late-fusion steps added to the JUFORMER model, which can alleviate the need for multiple transformer layers to learn more sophisticated representations. Another factor contributing to the reduction in the complexity of the JUFORMER model can be due to separating the audio-visual input space into each modality and processing them individually.

According to an embodiment, the AI device 100 can be configured to automatically determine an emotional state of a subject based on a video/audio segment. The AI device 100 can be used in various types of different situations.

According to one or more embodiments of the present disclosure, the AI device 100 can solve one or more technological problems in the existing technology, such as automatically determining a user's emotional state and providing tailored services based on the emotional state, in a more efficient and secure manner with a model that has a much reduced size.

Also, according to an embodiment, the AI device 100 configured with the JUFORMER AI model can be used in a mobile terminal, a smart TV, a home appliance, a robot, an infotainment system in a vehicle, etc.

Further, according to an embodiment, the AI device 100 including the JUFORMER model can implement a method that can provide a more efficient, accurate and privacy-conscious solution for emotion recognition.

For example, the AI device can be applied in a wide range of interactive applications including a digital assistant, a question and answering system, and a home robot. For example, according to an embodiment, the home robot can determine the user's emotional state and based on this information, the robot can perform a more relevant helping or caring action, or provide a better answer or information that more accurately addresses the user's needs.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
receiving, by a processor in the AI device, a video segment including a plurality of frames and an audio signal corresponding to the video segment;
processing the video segment, by a visual encoder, to generate a visual embedding;
processing the audio signal, by an audio encoder, to generate an audio embedding;
processing the visual embedding, by a unimodal visual transformer encoder, to generate an independent visual embedding vector based on self-attention;
processing the audio embedding, by a unimodal audio transformer encoder, to generate an independent audio embedding vector based on self-attention;
processing the visual embedding, by a joint visual transformer encoder, to generate a joint visual embedding vector using cross-attention based on information from the audio embedding;
processing the audio embedding, by a joint audio transformer encoder, to generate a joint audio embedding vector using cross-attention based on information from the video embedding;
processing the independent visual embedding vector, the independent audio embedding vector, the joint visual embedding vector and the joint audio embedding vector, by a fusion module, to generate a global fused embedding vector; and
generating an emotion prediction using a classifier module that analyzes the global fused embedding vector, and outputting the emotion prediction.

2. The method of claim 1, wherein the processing the independent visual embedding vector, the independent audio embedding vector, the joint visual embedding vector and the joint audio embedding vector, by the fusion module includes:
inputting the independent visual embedding vector and the joint visual embedding vector to a first partial fusion module to generate a first partially fused visual embedding vector;
inputting the independent audio embedding vector and the joint audio embedding vector to a second partial fusion module to generate a second partially fused audio embedding vector; and
processing the first partially fused visual embedding vector and the second partially fused audio embedding vector, by a global fusion module, to generate the global fused embedding vector.

3. The method of claim 2, further comprising:
generating the first partially fused visual embedding vector based on a sum of a first weight multiplied to the independent visual embedding vector and a second weight multiplied to the joint visual embedding vector; and
generating the second partially fused visual embedding vector based on a sum of a third weight multiplied to the independent audio embedding vector and a second weight multiplied to the joint audio embedding vector.

4. The method of claim 3, further comprising:
generating the global fused embedding vector based on a sum of a fifth weight multiplied to the first partially fused visual embedding vector and a sixth weight multiplied to the second partially fused visual embedding vector.

5. The method of claim 1, wherein the processing the visual embedding, by the joint visual transformer encoder, to generate the joint visual embedding vector using cross-attention includes using a query and a key received from the joint audio transformer encoder based on the audio embedding and a value internally generated by the joint visual transformer encoder based on the visual embedding.

6. The method of claim 1, wherein the processing the audio embedding, by the joint audio transformer encoder, to generate the joint audio embedding vector using cross-attention includes using a query and a key received from the joint visual transformer encoder based on the visual embedding and a value internally generated by the joint audio transformer encoder based on the audio embedding.

7. The method of claim 1, wherein the processing the video segment, by the visual encoder, to generate the visual embedding includes:
resizing the plurality of frames within the video segment to a size of N×N pixels to generate resized frames where N is a positive number;
dividing the resized frames into M×M non-overlapping patches where M is less than N;
applying a first convolutional neural network (CNN) to project the M×M non-overlapping patches into fixed-sized visual vectors, the visual embedding being one of the fixed-sized visual vectors.

8. The method of claim 1, wherein the processing the audio signal, by the audio encoder, to generate the audio embedding includes:
converting the audio signal to mel-spectrograms; and
applying a second convolutional neural network (CNN) to extract fixed-sized audio based vectors, the audio embedding being one of the fixed-sized audio based vectors.

9. The method of claim 1, wherein each of the unimodal visual transformer encoder, the unimodal audio transformer encoder, the joint visual transformer encoder and the joint audio transformer encoder includes only a single transformer block.

10. The method of claim 1, wherein one or more of the unimodal visual transformer encoder, the unimodal audio transformer encoder, the joint visual transformer encoder and the joint audio transformer encoder includes a transformer tower including a plurality of transformer blocks.

11. The method of claim 1, wherein the generating the emotion prediction using the classifier module includes:
mapping the global fused embedding to a set of probabilities corresponding to a plurality of emotions; and
selecting an emotion among the plurality of emotions having a highest probability as the emotion prediction.

12. An artificial intelligence (AI) device, comprising:
a memory configured to store video and audio information; and
a controller configured to:
receive a video segment including a plurality of frames and an audio signal corresponding to the video segment,
process the video segment, by a visual encoder, to generate a visual embedding,
process the audio signal, by an audio encoder, to generate an audio embedding,
process the visual embedding, by a unimodal visual transformer encoder, to generate an independent visual embedding vector based on self-attention,
process the audio embedding, by a unimodal audio transformer encoder, to generate an independent audio embedding vector based on self-attention,
process the visual embedding, by a joint visual transformer encoder, to generate a joint visual embedding vector using cross-attention based on information from the audio embedding,
process the audio embedding, by a joint audio transformer encoder, to generate a joint audio embedding vector using cross-attention based on information from the video embedding,
process the independent visual embedding vector, the independent audio embedding vector, the joint visual embedding vector and the joint audio embedding vector, by a fusion module, to generate a global fused embedding vector, and
generate an emotion prediction using a classifier module that analyzes the global fused embedding vector, and output the emotion prediction.

13. The AI device of claim 12, wherein the controller is further configured to:
input the independent visual embedding vector and the joint visual embedding vector to a first partial fusion module to generate a first partially fused visual embedding vector,
input the independent audio embedding vector and the joint audio embedding vector to a second partial fusion module to generate a second partially fused audio embedding vector, and
process the first partially fused visual embedding vector and the second partially fused audio embedding vector, by a global fusion module, to generate the global fused embedding vector.

14. The AI device of claim 13, wherein the controller is further configured to:
generate the first partially fused visual embedding vector based on a sum of a first weight multiplied to the independent visual embedding vector and a second weight multiplied to the joint visual embedding vector, and
generate the second partially fused visual embedding vector based on a sum of a third weight multiplied to the independent audio embedding vector and a second weight multiplied to the joint audio embedding vector.

15. The AI device of claim 14, wherein the controller is further configured to:
generate the global fused embedding vector based on a sum of a fifth weight multiplied to the first partially fused visual embedding vector and a sixth weight multiplied to the second partially fused visual embedding vector.

16. The AI device of claim 12, wherein the controller is further configured to:
generate the joint visual embedding vector using cross-attention based on a query and a key received from the joint audio transformer encoder based on the audio embedding and a value internally generated by the joint visual transformer encoder based on the visual embedding.

17. The AI device of claim 12, wherein the controller is further configured to:
generate the joint audio embedding vector using cross-attention based on a query and a key received from the joint visual transformer encoder based on the visual embedding and a value internally generated by the joint audio transformer encoder based on the audio embedding.

18. The AI device of claim 12, wherein the controller is further configured to:
resize the plurality of frames within the video segment to a size of N×N pixels to generate resized frames where N is a positive number,
divide the resized frames into M×M non-overlapping patches where M is less than N,
apply a first convolutional neural network (CNN) to project the M×M non-overlapping patches into fixed-sized visual vectors, the visual embedding being one of the fixed-sized visual vectors.

19. The AI device of claim 12, wherein the controller is further configured to:
convert the audio signal to mel-spectrograms, and
apply a second convolutional neural network (CNN) to extract fixed-sized audio based vectors from the mel-spectrograms, the audio embedding being one of the fixed-sized audio based vectors.

20. The AI device of claim 12, wherein each of the unimodal visual transformer encoder, the unimodal audio transformer encoder, the joint visual transformer encoder and the joint audio transformer encoder includes only a single transformer block.
